(19) United States
(12) Patent Application Publication
(10) Pub. No.: US 2010/0225273 A1
(43) Pub. Date: Sep. 9, 2010

(54) Electromechanical Vampire Proof Battery Charger

(76) Inventor: Jeffrey R. Eastlack, Austin, TX (US)

Correspondence Address: Ruay L. Ho, 1045 North Utah Street, # 502, Arlington, VA, 22201, US

(21) Appl. No.: 12/718,122

(22) Filed: Mar. 5, 2010

Related U.S. Application Data
(60) Provisional application No. 61/157,565, filed on Mar. 5, 2009.

(51) Int. Cl. H02J 7/00

(52) U.S. Cl. 320/108; 320/107; 320/114

(57) ABSTRACT

Vampire energy loss occurs when an electronic or mechanical machine or device consumes energy while not being utilized for the purpose of its existence. An electromechanical switching method is provided to eliminate vampire energy loss in battery chargers. The switching method includes a short circuit which is created and eliminated by disconnecting and plugging in a target device to the charger thus consequently applying force to a push button switch. There is no hardware support circuitry required from target devices.

This application claims the benefit of U.S. Provisional Application No. 61/157,565, filed on Mar. 5, 2009, which is incorporated herein by reference.

### FIELD OF INVENTION

The present invention relates to power efficient battery chargers and technology. Particularly, the present invention relates to power chargers that eliminate vampire energy loss or no load loss using an electromechanical switching method.

### BACKGROUND OF THE INVENTION

The basic DC power supply or battery charger, as shown in FIG. 1, plugs into an AC power source 102 through a wall receptacle and employs the use of a step-down transformer 104, signal rectification circuitry 106, and voltage regulation circuitry 108. The transformer consists of two conductively independent coils that are mutually coupled by magnetic flux when current flows in one of them.

For instance, the AC current flowing in the primary coil of FIG. 1 produces a changing magnetic field within the transformer core. Thereby, it induces an electric current in the secondary coil as described by Faraday's Law.

When any charger is not in use, there can be some “no-load loss”. From transformer theory “no-load loss” is energy loss that occurs even when the secondary coil is left open or not attached to a load. According to academic literature, the cause of no-load loss within transformers is attributed to eddy currents and magnetic hysteresis within the transformer core.

In addition to no-load loss from the transformer, DC power supplies also incur dynamic and static power loss within the rectification and regulation circuitry. All of these combined losses within the DC power supply attribute to a significant portion of “vampire energy loss” which exists in many electronic product domains.

Various techniques have been developed in place to reduce no-load loss within transformers. However, the only way to entirely stop no-load loss of the DC power supply or charger is to completely disconnect it from the power grid.

There are existing solutions, such as the USB Ecostrip and the Smart Power Strip, for reducing vampire power loss. But, these existing solutions are markedly different from the present invention, and each has disadvantages required further developments and improvements.

The first of these inventions is the USB Ecostrip. In the design of this USB connected power strip, the power bus of a standard USB compliant port of a host device is used to provide the power to the switching mechanisms of the power strip. If the USB host is turned off then the power strip has no power for other devices on the power strip.

In another power strip design called the Smart Power Strip, one master outlet on the strip controls six other slave outlets. When the power usage of the master outlet decreases, it automatically turns off the slave outlets. The smart power strip monitors the power usage of a master device and makes the assumption that a slave device adheres to the same use case as the master device.

Unfortunately, there are many possible cases where slave devices require power during times that a master device does not. These conditions may limit the functionality of both the USB Ecostrip and the Smart Power Strip for many peripheral devices which could result in vampire energy loss.

These solutions and many other solutions available in the market differ from the present invention as they all use a mixed assortment of electronic devices and components to implement the control and disconnect of the charger from the power grid. In addition to using electronic devices and components, many of these solutions lack an application specific shutdown mechanism.

Some of the solutions employ the use of many electronic devices and components. Mobile device battery chargers are very much a commodity electronic product that is extremely price sensitive. A viable solution must be able to be implemented at a low cost.

Therefore, there is a need for a cost effective battery charger that eliminates vampire or no-load energy loss without the use of costly circuitry and with the ability to be used without hardware support on the target device or machine.

### SUMMARY

Accordingly, it is an object of the present invention to provide an electromechanical vampire proof battery charger which requires the use of a custom switch next to the DC port target connection terminal to implement a mechanical switching mechanism to disconnect the battery charger from the electric power grid.

It is another object of the present invention to provide an electromechanical vampire proof battery charger to support existing target devices without hardware support circuitry from the target device.

It is also another object of the present invention to provide an electromechanical vampire proof battery charger with a push button switch placed next to a DC power connector plug at the end of the wire. The push button switch can be placed next to many different connector types.

A short circuit is implemented by a pushbutton switch provided to prevent no-load loss. When the charge session is finished and the charger no longer connected to the target device, no-load loss is prevented by created an open circuit in the pushbutton switch.

Other objects, advantages and novel features of the present invention will become more apparent from the following detailed description when taken in conjunction with the accompanying drawings.

### BRIEF DESCRIPTION OF THE DRAWINGS

FIG. 1 illustrates the basic components of a typical battery charger without vampire proof capabilities;

FIG. 2 illustrates a schematic diagram showing the electrical implementation of the pushbutton switch circuit of a preferred embodiment of the present invention;

FIG. 3A illustrates a top view of a preferred embodiment of the present invention of hybrid pushbutton switch using a USB Micro-B connector plug as an example to deliver the DC power and ground signals;

FIG. 3B illustrates a front view of a preferred embodiment of the present invention of the hybrid pushbutton switch using a USB Micro-B connector plug as an example to deliver the DC power and ground signals;

FIG. 3C illustrates a side view of a preferred embodiment of the present invention of the hybrid pushbutton switch using a USB Micro-B connector plug as an example to deliver the DC power and ground signals;

FIG. 4A illustrates a top view of a preferred embodiment of the present invention of the hybrid pushbutton switch and connector port using a standard concentric barrel connector with DC power lines on the inner and outer conductors;

FIG. 4B illustrates a front view of a preferred embodiment of the present invention of the hybrid pushbutton switch and connector port using a standard concentric barrel connector with DC power lines on the inner and outer conductors;

FIG. 4C illustrates a side view of a preferred embodiment of the present invention of the hybrid pushbutton switch and connector port using a standard concentric barrel connector with DC power lines on the inner and outer conductors;

FIG. 5 illustrates a usage flow chart of a preferred embodiment of the present invention showing a temporal operation of an electromechanical vampire proof battery charger;

FIG. 6 illustrates an image of a preferred embodiment of a charger hardware of the electromechanical vampire proof charger of the present invention being realized with a pushbutton switch and a connector plug; and

FIG. 7 illustrates a preferred embodiment of the present invention expanded to other products, including various types of battery operated portable devices and other electric machines.

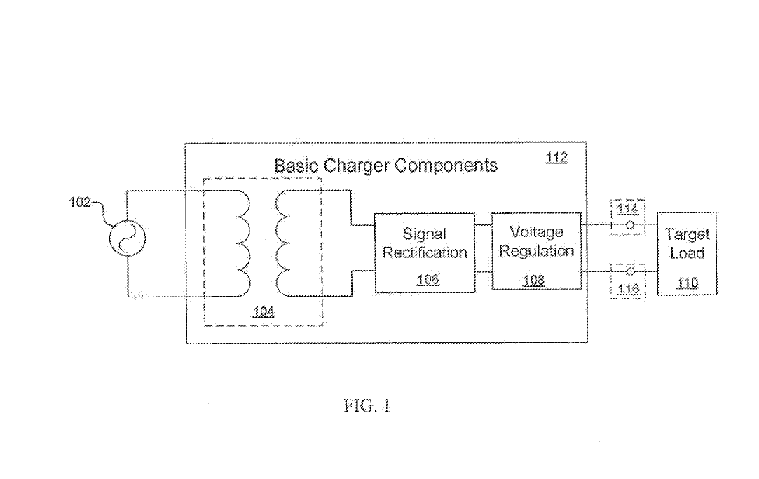

### DETAILED DESCRIPTION OF THE INVENTION

Now referring to FIG. 2, an AC power source 102, a set of charger components 206, and a target device 110 are depicted. The basic battery charger or DC power supply circuitry 112 is slightly augmented 206 to allow one port of the AC power source 102 to be routed to the target device 110 for feedback directly or indirectly, such as via a solid state device circuitry, to the primary coil of the step down transformer 104.

A pushbutton switch mechanism is employed in this preferred embodiment to eliminate vampire energy loss. There are two ports 202 and 204 and two DC power signals 114 and 116. The basic charger 112 includes a step-down transformer 104, a signal rectification circuitry 106, and a voltage regulation circuitry 108.

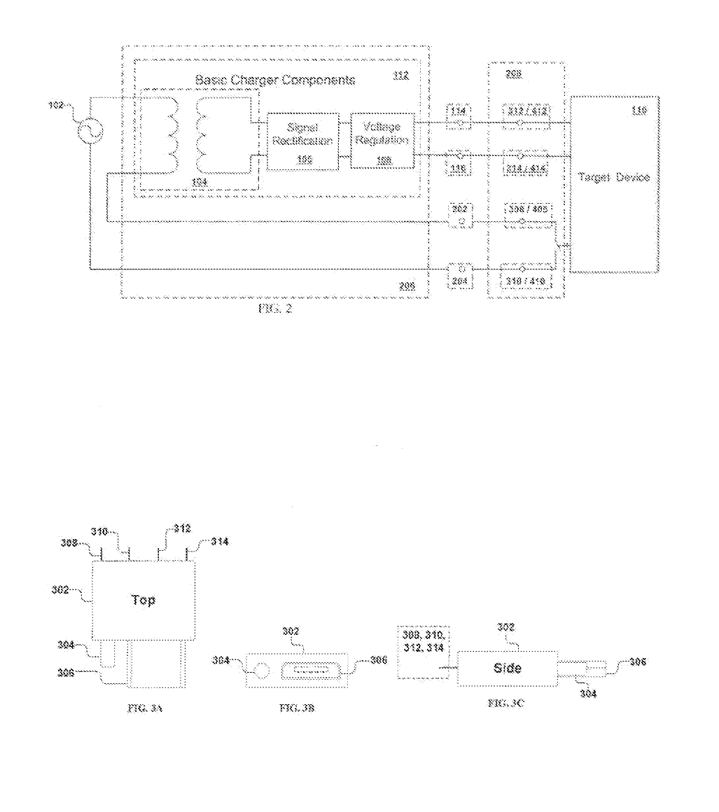

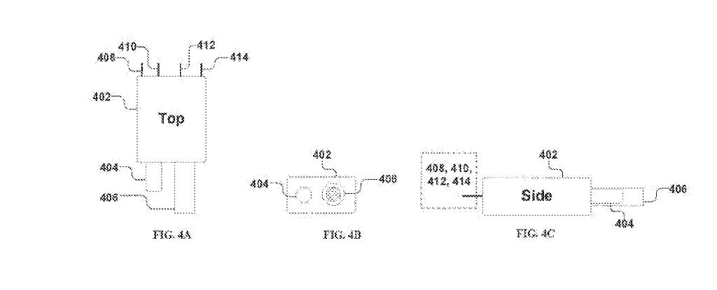

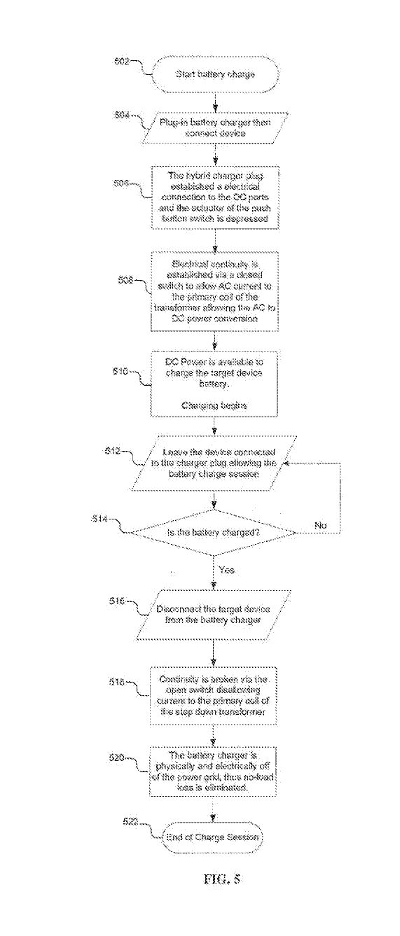

Specifically, referring to FIGS. 3A, 3B, 4A, 4B, the circuitry 112 is slightly augmented as shown in 206 to allow one port of the AC power source 102 to be routed via AC signal port 204 to the end of a connector device to the first terminal 310 or 410 of the pushbutton switch 304 or 404 while AC feedback signal port 202 is connected to the second terminal 308 or 408 of the pushbutton switch inside 208.

The electromechanical vampire proof battery charger as shown in FIG. 2 requires the use of a pushbutton switch 304 or 404 to be physically placed next to the DC power and ground connection ports 312 or 412 and 314 or 414 which are delivered via connection plug terminal described in either 306, as shown in FIG. 3A, or 406, as shown in FIG. 4A.

Further detailed mechanical depictions are referred to FIGS. 3A-3C. Both FIG. 3A and FIG. 3B show the schematic layout of USB Micro-B connector with push button switch. The actual switching mechanism is realized in the form of the pushbutton switch which is physically placed next to the DC power connector plug inside the same enclosure, as mechanically seen in FIG. 3A, FIG. 3B, and electrically in 208 of FIG. 2.

Specifically, the charger is turned on when the actuator of the pushbutton switch makes physical contact with the target or mobile device enclosure when the target device is plugged into the charger. The force from the target device enclosure exerts onto the charger and put pressure on the actuator, which is therefore depressed as a consequence.

Therefore, the spring force constant of the push button switch must be less then the frictional force constant of the connector plug type. If the force from the spring is greater than the frictional force of the connector, the consequences are that the push button switch will inadvertently pull the charger connector tip out of the connector socket of the target device.

The connector examples given in FIGS. 3A to 4C illustrate the use of a USB Micro-B plug 306, and a standard barrel connector 404; USB power and ground signals 312 and 314 respectively are however connected to DC voltage signals. But, it is important to note that this preferred embodiment is not exclusive to the USB Micro-B plug or barrel connector and can be applied to many different connector types. It is also important to note that USB standard signals Data Negative (DN), Data Positive (DP), and Identification signal (ID) are ignored in this embodiment as they are unnecessary for the realization of the present invention.

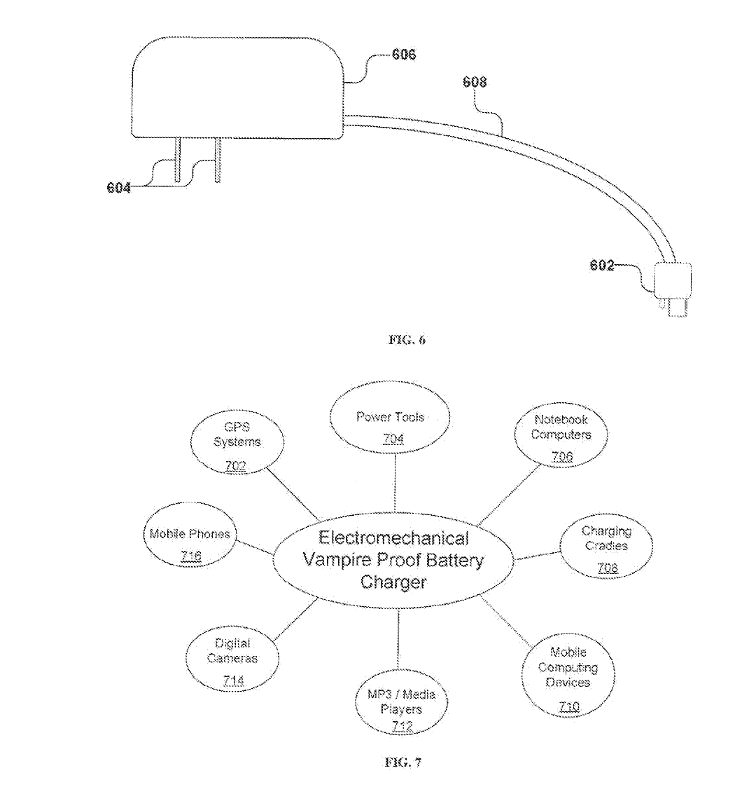

Flowchart of FIG. 5 illustrates preferred operational steps. To initiate a charge session 502, the charger's prongs must be plugged into the wall receptacle 504 and the target device must be connected to the hybrid pushbutton switch and connection terminal described electrically in 208 and mechanically in FIGS. 3A-C and FIGS. 4A-C. As a consequence of the connector terminal 306 or 406 being connected to the target device from the actions of step 504, the actuator of the pushbutton switch is depressed or “pushed” via physical contact from the target device.

When the actuator of the pushbutton switch 304 or 404 is depressed, a conductive path from AC signals 202 and 204 is established as described temporally in step 506. With this conductive path established between the AC power source 102 and the step-down voltage transformer 104, AC current is allowed to flow directly or indirectly through the primary coil of the transformer 104 and magnetic coupling between the secondary coil commences to allow a stepped down AC current to the rectification circuitry 106 and then DC power to the regulation circuitry 108 of the DC power supply or battery charger 112 as shown in step 508.

DC power is now available to charge the target device and charging commences as shown in 510 and 512. The charge session continues when the battery is not fully charged 514. Once the battery is fully charged, the user can disconnect the target device 110 from the charger connection terminal 516. The disconnecting of the target device from the charger consequently removes contact force on the pushbutton switch 304 or 404 and thus electrically opens the switch, causing broken continuity 518 between AC signals 202 and 204.

With continuity broken from AC signals 202 and 204, current is not able to flow through the primary coil of the step down transformer 104. With broken continuity from the AC power source 102 and the transformer 104, the charger is now physically and electrically disconnected from the AC power source 520; however, prongs are not unplugged from the wall receptacle.

In this scenario the battery charger is electrically taken off of the power grid without having to remove the charger from the wall receptacle; thus, the vampire energy losses associated with battery chargers when the load or target device is not attached is eliminated. Finally, the charge session ends 522. This implementation concept can be applied to other mobile electronic devices and machines and is not limited to those illustrated in FIG. 9.

A very important detail of the present invention is to align the pushbutton switch 304 or 404 to the adjacent connector terminal 306 or 406 within the enclosure 302 or 402 to where the relative distance from the physical edge of the target device is such that contact with the enclosure of the target device and hybrid plug 602 causes the pushbutton switch to depress and initiate a short circuit to AC signals 202 and 204 when the connector terminal 306 or 406 is fully inserted into the connector terminal of the target device.

The overall exterior of the charger of a preferred embodiment of the present invention is shown in FIG. 6. The prongs 604 for connecting to the AC power source and the enclosure 606 includes the augmented power supply circuitry. The hybrid connector 602 which is described mechanically in FIGS. 3A-3C and FIGS. 4A-4C has port terminals 308, 310, 312, 314 and 408, 410, 412, 414, not shown in FIG. 6 as they are covered by the enclosure 602. The conductive wires connecting signals 114, 116, 202, and 204 are also enclosed by insulating wire tubing shown in 608.

Now refer to FIG. 7, many applications and mobile devices that the electromechanical switching mechanism of the present invention can be applied to or integrated into are shown in the schematic diagram, such as GPS systems 702, power tools 704, notebook computers 706, mobile phones 708, mobile computing devices 710, MP3/media Player 712, digital cameras 714, and mobile phones 716. Many other applications and devices can also be utilized coupled with the electromechanical switching mechanism of the present invention.

The aforementioned preferred embodiments of the present invention were chosen and described in order to best explain the principles of the present invention and the practical applications, and best understand the present invention for various embodiments with various modifications as are suited to the particular use contemplated.

The description of the present invention has been presented for purposes of illustration and description, but is not intended to be exhaustive or limited to the present invention in the form disclosed. Modifications and variations will be apparent to those skilled in the art without departing from the scope and spirit of the invention.

What we claimed is:

1. A charger for recharging energy with eliminated vampire loss comprises:
a charger enclosure;
a plurality of prongs for connecting to a power source; and
a connecting plug containing an open circuit for connecting to a target load.

2. The charger for recharging energy as claimed in claim 1, wherein the charger enclosure comprises a transformer, a signal rectification circuitry, and a voltage regulation circuitry.

3. The charger for recharging energy as claimed in claim 1, wherein the connection plug includes four signal ports; and two of the ports are connected in series to the power source and a circuitry connecting directly or indirectly via solid state device circuitry to the primary coil of the transformer within the charger enclosure.

4. The charger for recharging energy as claimed in claim 3, wherein the two ports connected in series to the power source containing an open circuit when no target device is connected.

5. The charger for recharging energy as claimed in claim 4, wherein the open circuit in the push button switch at the connection plug is depressed to close by a target device as a consequence of the mechanical coupling between the connector plug and socket during recharging process.

6. The charger for recharging energy as claimed in claim 5, wherein the open circuit at the connection plug is re-opened when not depressed by the target load after finishing recharging.

7. The charger for recharging energy as claimed in claim 1, wherein the connection plug comprises USB Micro-B connection.

8. The charger for recharging energy as claimed in claim 1, wherein the connection plug comprises Standard barrel connection.

9. The charger for recharging energy as claimed in claim 1, wherein the target device can be a plurality of applications and mobile devices.

10. The charger for recharging energy as claimed in claim 9, wherein the applications is all battery operated mobile devices.

11. The charger for recharging energy as claimed in claim 9, wherein the mobile devices are power tools, notebook computers, mobile phones, digital cameras, and MP3/Media players.

12. The charger for recharging energy as claimed in claim 1, wherein the charger power conversion circuit does not consume vampire or phantom energy even when it is plugged into the power source.
